(19) United States
(12) Patent Application Publication
(10) Pub. No.: US 2023/0259107 A1
(43) Pub. Date: Aug. 17, 2023

(54) EFFICIENT ROBOTIC DEFECT CORRECTION SYSTEM AND METHOD

(71) Applicant: INOVISION SOFTWARE SOLUTIONS, INC., Chesterfield, MI (US)

(72) Inventor: Andrew Gary Gagne, Orion Township, MI (US)

(21) Appl. No.: 18/168,777

(22) Filed: Feb. 14, 2023

Related U.S. Application Data
(60) Provisional application No. 63/309,776, filed on Feb. 14, 2022.

(51) Int. Cl. G05B 19/418

(52) U.S. Cl. CPC G05B 19/41875; G05B 19/4189; G05B 19/4182

(57) ABSTRACT

A multi-track conveyor system may include an input track. A multi-track conveyor system may include an output track. A multi-track conveyor system may include a plurality of tracks coupling the input track and the output track, wherein one of the tracks includes a workstation configured to repair the defect on the article of manufacture. Vehicles with high numbers of defects that exceed the system throughput design can be held and prioritized over vehicles which meet the system design criteria to maintain throughput. During times when the system is starved and/or during non-production hours, vehicles with higher numbers of defects can then be processed. In this way, such vehicles do not impede the repair progress of other vehicles along the conveyor system.

### CROSS-REFERENCE TO RELATED APPLICATIONS

This application claims the benefit of U.S. Provisional Application No. 63/309,776, filed on Feb. 14, 2022. The entire disclosure of the above application is incorporated herein by reference.

### FIELD

The present technology relates to quality control, and more particularly, to paint defect repair.

### INTRODUCTION

This section provides background information related to the present disclosure which is not necessarily prior art.

Paint repair is one of the last remaining steps in the vehicle manufacturing process that is still predominantly performed as a manual process. Undesirably, the painting process in a manufacturing environment can often yield paint defects that can occur on the surface of the part being painted. These imperfections can be caused by dirt, craters, fibers, or other contaminants in the paint, air, or present on the part. Defects in the finish of the surface of the painted part are undesirable for the finished manufactured product.

In particular, paint defects can create a bump on a relatively flat surface of a part. These bumps are often repaired manually using a paint finesse process, such as the 3M Finesse-It™ System. These processes typically involve sanding the bump to flatten the surface and then polishing the sanded area to remove the scratch marks created by the sanding step. The polishing process can use a polish and a random orbital polishing tool. The polish can be applied to the defect area and then the area can be polished using the random orbital polishing tool with a buffing pad.

Current solutions to paint defect repair unfortunately present certain inefficiencies. For example, a portion of human operators and/or robots assigned to a repair process can be sitting idle for all or part of an allotted cycle time to repair a paint defect. In an extreme example, a vehicle can either have no defects or can have more defects than can be repaired in the allotted cycle time, resulting in the operators/robots being idle for an entirety of the repair cycle time. If more time than allotted is required to repair all the defects, for example, a conveyor system moving the vehicle(s) may have to be stopped to complete the repairs. Stopping the conveyor system results in a loss of production. If more time than allocated is required to repair all the defects, but the conveyor system cannot be stopped, for example, the vehicle must be taken offline to finish correcting the defects. Such scenarios detract from efficiently processing vehicles having minimal defects, or a number of defects below a threshold that can be managed by the system. Another problem with the typical finesse deck process is that every vehicle travels down the same conveyor and takes up the same cycle time regardless of the time required to correct the defect(s) on the vehicle. In reality, it is likely that every vehicle will take either more or less time than a predetermined or allotted amount of time, which can at best be based on a working average, thereby creating a very inefficient process.

Accordingly, there is a need for optimizing the overall throughput and efficiency of the paint defect repair process based upon the paint defect repair(s) necessary for a particular vehicle by disconnecting manual repair steps from automated repair steps to make more production time available.

### SUMMARY

In concordance with the instant disclosure, ways of optimizing the overall throughput and efficiency of the paint defect repair process based upon the paint defect repair(s) necessary for a particular vehicle by disconnecting manual repair steps from automated repair steps to make more production time available, have surprisingly been discovered.

Embodiments of the present disclosure can include a multi-track conveyor system for repairing a defect on an article of manufacture. Such systems can include an input track, an output track, and a plurality of tracks coupling the input track and the output track. The plurality of tracks can include a plurality of workstations where at least one of the tracks can include a workstation configured to repair a defect on the article of manufacture. Each track with the workstation can be configured to receive articles of manufacture for repair with specified defects. The specified defects on the article of manufacture can be dependent on several different factors such as the location of the defect, the number of instances of the defect, the type of the defect, the predetermined time to repair the defect, among other factors. In some embodiments, the multi-track conveyor system can include a manual inspection area coupled to the plurality of tracks that is configured to allow for manual repair of the defect on the article of manufacture.

The multi-track conveyor system can also include an object inspection system, a bypass track, and a lift table. The object inspection system can be coupled to the input track or the output track and can be configured to identify the specified defect on the article of manufacture. The object inspection system can direct the article of manufacture to the workstation that is configured to repair the specified defect. Further, the object inspection system can be configured to ascertain whether the defect on the article of manufacture is repaired by determining whether the repair meets a predetermined threshold before directing the article of manufacture to the output track. Additionally, the bypass track can be coupled the input track and a second output track and can be configured to selectively receive the article of manufacture from the input track. Another object inspection system can be configured to operate the bypass track to receive the article of manufacture when the defect is below a predetermined threshold. The lift table can be configured to transport the article of manufacture to the workstation and from the input track to the output track.

Embodiments of the present disclosure can also include a method for repairing a defect on an article of manufacture, including steps of providing a multi-track conveyor system including an input track, an output track, and a plurality of tracks coupling the input track and the output track. Additionally, one of the tracks can include a workstation configured to repair the defect on the article of manufacture. Embodiments can also include providing the article of manufacture on the input track and further identifying the defect on the article of manufacture. Embodiments can then include directing the article of manufacture to the track including the workstation and finally, repairing the defect using the workstation.

In some aspects, the embodiments described herein relate to a multi-track conveyor system for repairing a defect on an article of manufacture, including: an input track; an output track; and a plurality of tracks coupling the input track and the output track, wherein one of the tracks includes a workstation configured to repair the defect on the article of manufacture.

In some aspects, the embodiments described herein relate to a method for repairing a defect on an article of manufacture, including steps of: providing a multi-track conveyor system including: an input track; an output track; a plurality of tracks coupling the input track and the output track, wherein one of the tracks includes a workstation configured to repair the defect on the article of manufacture; providing the article of manufacture on the input track; identifying the defect on the article of manufacture; directing the article of manufacture to the track including the workstation; and repairing the defect using the workstation.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic top plan view of a single-track conveyor having three workstations positioned within a manual inspection/repair area.

FIG. 2 is a schematic top plan view of a multi-track conveyor having three workstations, each workstation positioned within a separate track that diverges from a common input track and converges to a common output track, the output track includes a manual inspection area, where an additional track diverges from the input track that includes another manual inspection area in parallel.

FIG. 3 is a schematic top plan view of a multi-track conveyor having four workstations, each workstation positioned within a separate track that diverges from a common input track and converges to a common output track, where a bypass track directly connects the input track to the output track and bypasses the separate tracks and respective workstations.

FIG. 4 is a flow diagram depicting a method for repairing a defect on an article of manufacture.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as can be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items can be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that can arise from ordinary methods of measuring or using such parameters.

All documents, including patents, patent applications, and scientific literature cited in this detailed description are incorporated herein by reference, unless otherwise expressly indicated. Where any conflict or ambiguity can exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments can alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that can be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter can define endpoints for a range of values that can be claimed for the parameter. For example, if Parameter X is exemplified herein to have value A and also exemplified to have value Z, it is envisioned that Parameter X can have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X can have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it can be directly on, engaged, connected or coupled to the other element or layer, or intervening elements or layers can be present. In contrast, when an element is referred to as being “directly on,” “directly engaged to,” “directly connected to” or “directly coupled to” another element or layer, there can be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. can be used herein to describe various elements, components, regions, layers and/or sections, these elements, components, regions, layers and/or sections should not be limited by these terms. These terms can be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, can be used herein for ease of description to describe one element or feature's relationship to another element(s) or feature(s) as illustrated in the figures. Spatially relative terms can be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

The present technology relates to ways for efficiently employing robotic paint defect correction in paint defect repair for conveyed articles of manufacture, such as vehicle bodies. Multi-track conveyor systems for repairing a defect on an article of manufacture can include a plurality of tracks coupling an input track and an output track, where at least one of the tracks of the plurality of tracks includes a workstation configured to repair the defect on the article of manufacture. Methods for repairing a defect on an article of manufacture can employ such systems and can include the following operations. The article of manufacture can be provided on the input track. The defect can be identified on the article of manufacture. The article of manufacture can be directed to the track including the workstation. The defect can be repaired using the workstation.

Advantages of the present technology include increases in the overall throughput and efficiency of the paint defect repair process as the system is only using the required cycle time determined by the required repairs. Also, not having an automated process tied to a manual process allows more production time to be available.

Certain technologies allow for automatic defect detection to determine the quantity and severity of paint defects on a vehicle. For example, various systems and processes can be used to identify and subsequently repair paint defects. These can include detection systems, optical systems, and cameras that identify and map paint defects and various robots, end tooling, and defect repair steps that can be coordinated in a partially or completely automated fashion to repair identified defects. Such systems and processes can be incorporated at one or more points in the vehicle manufacturing process. Examples include those described by U.S. Pat. No. 11,310,467 titled OBJECT INSPECTION SYSTEM AND METHOD FOR INSPECTING AN OBJECT and those described by U.S. Pat. Appl. Pub. No. 2021/0394219 titled SYSTEM AND METHOD FOR DEFECT REPAIR, where the disclosures of each are incorporated herein by reference. Locating and understanding the nature of required paint defect repairs before a vehicle is brought to a repair workstation allows for prioritizing vehicles that can be repaired within the allotted cycle time and allows for planning how a vehicle gets processed before it is brought to the repair workstation.

Certain workstations and operations thereof can be controlled or operated with predetermined parameters, including repair cycle times that can be particular to certain defect repair operations for particular paint defects; e.g., debris, scratch, run or drip, etc. A controller configured to operate a workstation can provide one or more completion times for one or more defect repairs in a defect repair queue sent to the workstation. Cycle times for defect repair steps can be determined prior to sending a vehicle to a particular workstation. In this way, repair time(s) for certain defects for a given workstation and a given vehicle having a given number/type of defect(s) can be estimated. The present systems and methods can therefore plan and schedule the routing of vehicles having paint defects in need of repair to workstations based upon various parameters, including repair cycle time, nature of paint defect, number of paint defects, location of paint defect(s), architecture/geometry of the particular workstation, architecture/geometry of the particular vehicle, whether the vehicle should pass through multiple workstations, etc.

With a manual and/or automated moving line finesse deck on a single-track conveyor system, each vehicle is allotted a predetermined cycle time for the paint defect repair process. The sequential, straight-line nature of the single-track system, where each vehicle passes through the entire work zone, is limited by the work required on a vehicle-by-vehicle basis. When inspection data is available, the required paint defect repair time can be calculated and used in planning on how to process a vehicle. If a vehicle has no defects, the repair process can be bypassed. Similarly, if a skid on such a single-track system does not contain a production vehicle, one that has too many defects, or one that has defects that cannot be repaired by the finesse process, such skids can be bypassed and directed to an area which can handle issues presented by vehicles exhibiting such instances.

A conveyor system, however, can have an altered layout that can include multiple tracks, including multiple diverging and/or converging tracks. Such conveyor systems can include inverted power and free conveyor systems. In this case, vehicles which do not meet the automated finesse criteria can be routed to an alternate repair deck. Vehicles which do not have any defects can be routed around the automated repair deck. When vehicles meet the automated repair deck criteria, they are routed into one of a number of automated repair decks. Where previously the vehicle would be continuously moving though the repair process, in this case the vehicle would stop on the automated repair deck. The vehicle would only stop for the time required to repair all of the defects or the maximum allotted cycle time of the cell. This allows for the vehicle to be in the automation zone for the time needed to make the defect repairs and not a predetermined amount of cycle time regardless of time to repair the necessary defects. Other conveyor systems include power roll bed conveyor systems. Using similar branching, vehicles can be routed through or around automated repair workstations depending on skid type and repair types/length.

The present technology can further include the following additional aspects. Vehicles with high numbers of defects that exceed the system throughput design can be held and prioritized over vehicles which meet the system design criteria to maintain throughput. During times when the system is starved and/or during non-production hours, vehicles with higher numbers of defects can then be processed. In this way, such vehicles do not impede the repair progress of other vehicles along the conveyor system.

With a single-track system, the number of defects that can be repaired by design is based on the assumption that the defects are equally spaced over the vehicle and always accessible to the robot. In reality, defects can be clustered together, limiting the number of robots that can work on the vehicle in a given area. Since the cycle time is predetermined, defects cannot get repaired in the cycle time available as the one or more robots with limited access to the defect site may not have enough time to attend to the number of defects. All the while, other robots with access to other areas of the vehicle sit idle. With the present multi-track system, since the estimate repair times are known, the multi-track system can anticipate the next open repair area and route vehicles accordingly.

More vehicle assembly facilities are now producing a wider spectrum of vehicles which can employ different repair techniques, have different repair requirements or thresholds, and/or necessitate different workstation spatial layouts or geometry due to different vehicle shapes and sizes. The present multi-track conveyor layouts allow for different repair techniques in each workstation and can be coordinated based on the production ratio. In particular, a facility producing vehicles that vary largely in size can design the repair workstations to vary in size with the production ratios. Facilities producing vehicles with different quality specifications can likewise use the multi-track conveyor to account for the potentially large variance in repair time. For example, if vehicle model X requires defects 1.5 mm or greater to be repaired, whereas vehicle model Y requires defects of 1 mm or greater to be repaired, the average number of defects per vehicle will likely be higher on model Y versus model X.

It should be understood that although the present technology is generally described as being applicable to paint defects on vehicles in a vehicle assembly facility, other types of quality control processes or defect repair or remediation are contemplated, including other substrates or articles of manufacture beyond vehicles. For example, there is a broad range of articles of manufacture or components thereof that have at least one layer of paint and/or finish applied during a manufacturing process. Non-limiting examples can include various painted parts for various vehicles (e.g., automobiles, trucks, trains, boats, airplanes, helicopters, etc.) and various consumer goods (e.g., appliances, electronic devices, furniture, building materials, etc.). The layer of paint including the defect can also include a layer of e-coat, filler, primer, and/or clear coat. It should be appreciated that a skilled artisan can select different articles of manufacture and/or different layers of paint, coatings, and finishes to be used with the present systems and methods, as desired.

As referred to herein, a paint defect can broadly refer to an area on the article of manufacture that interrupts a visual aesthetic. For example, the paint defect can include debris trapped under the layer of paint, smudges in the layer of paint, excess paint, such as smears or dripping, dents, contaminants in the paint, and/or scratches in the layer of paint. However, it should be appreciated that one skilled in the art can select different types of defects to be categorized as a paint defect, within the scope of this disclosure. In addition, it should be appreciated that there can be multiple paint defects and/or multiple types of paint defects on the article of manufacture.

The multi-track conveyor system can include a means for identifying the paint defect, a workstation including one or more robots configured to perform one or more paint defect correction processes, and a computer module to control the direction of vehicles having identified or mapped defects to certain tracks or branches of the multi-track conveyor system. As described, certain tracks can be tailored for certain types of defects, certain types of vehicles, and/or certain paint defect correction standards. The means for identifying and/or mapping the paint defect can include various types of identifying technologies and techniques. In certain embodiments, the means for identifying the paint defect can include an object inspection system and method, as described in U.S. Pat. No. 11,310,467 titled OBJECT INSPECTION SYSTEM AND METHOD FOR INSPECTING AN OBJECT and those described by U.S. Pat. Appl. Pub. No. 2021/0394219 titled SYSTEM AND METHOD FOR DEFECT REPAIR.

The object inspection system can be configured to identify the paint defect by measuring perturbations in light reflected off the paint defect of the part. In another non-limiting example, the means for identifying the paint defect can include a system and method for detecting texture differences across different portions of the part. Further non-limiting examples can include a participation of a human operator or worker who manually identifies one or more paint defects and can optionally employ one or more machine vision (MV) cameras to identify the paint defect(s). The MV cameras can include conventional (2D visible) light imaging, multispectral imaging, hyperspectral imaging, imaging various infrared bands, line scan imaging, 3D imaging of surfaces and/or X-ray imaging. It should be appreciated that a person skilled in the art can employ different technologies and methods for the means for identifying the paint defect, based on the needs for the given application.

### Examples

Example embodiments of the present technology are provided with reference to the several figures enclosed herewith.

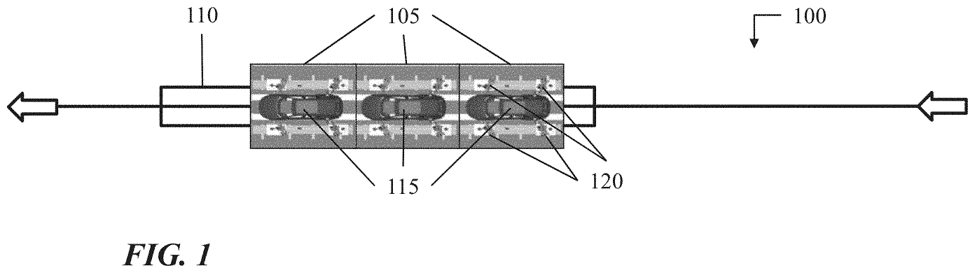

With reference to FIG. 1, a single-track conveyor system 100 having three workstations 105 positioned within a manual inspection/repair area 110, is shown. Three vehicles 115 are shown, where each vehicle 115 is located within one of the workstations 105, respectively. As shown, the workstations 105 are positioned within the manual inspection area 110, but other embodiments can have the workstations 105 positioned separately from the manual inspection area 110. Each workstation 105 can include multiple robots 120, where four robots 120 are shown positioned approximately with respect to the four corners of the vehicle 115.

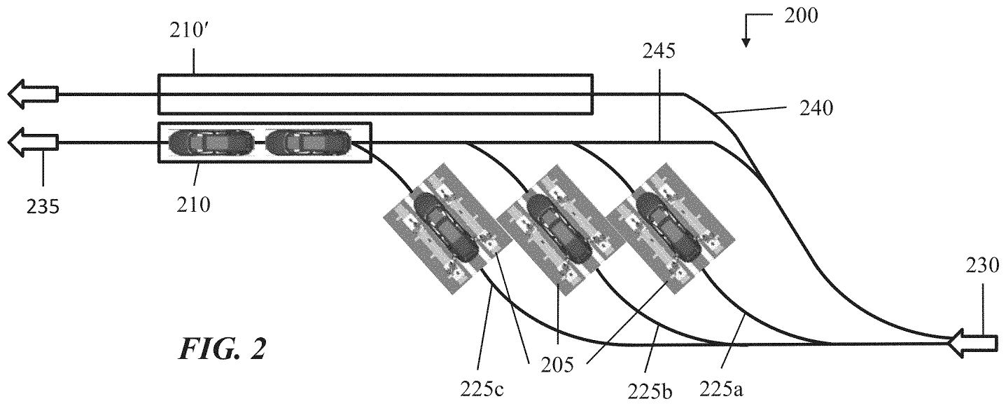

With reference to FIG. 2, a multi-track conveyor system 200 is shown having three workstations 205, where each workstation 205 is positioned within a separate track 225a, 225b, 225c that diverges from a common input track 230 and converges to a common output track 235. The output track 235 can include a manual inspection area 210. An additional track 240 can diverge from the input track 230, where the additional track 240 includes another manual inspection area 210′ in parallel. It is also possible to route vehicles from the input track 230 to the output track 235 via a bypass track 245, thereby bypassing the workstations 205 and proceeding to the manual inspection area 210 and output track 235. It should also be understood that there can be multiple tracks feeding into the input track 230 and multiple outputs departing from the output track 235. Likewise, the input track 230 can include multiple separate input tracks 230 and the output track 235 can include multiple separate output tracks 235. Multiple input tracks 230 and output tracks 235 can also include one or more additional bypass tracks 245.

The multi-track conveyor system 200 shown in FIG. 2 provides an example layout of a system which utilizes an inverted power and free conveyor. In this case, vehicles which do not meet the automated finesse criteria can be routed to the manual inspection area 210′ of the additional track 230. Vehicles which do not have any defects can be routed around the workstations 205 via the bypass track 245. When vehicles meet the automated workstation criteria, such vehicles are routed into one of the tracks 225a, 225b, 225c leading to an appropriate workstation 205. Where previously the vehicle would be continuously moving though the repair process, in this case, the vehicle can stop at the selected workstation 205. The vehicle can stop only for the time required to repair all of the defects or the maximum allotted cycle time of the workstation 205. This allows for the vehicle to be in the automation zone for the time needed to make the paint defect repair(s) and not a predetermined amount of cycle time regardless of time to repair the necessary defects.

Although single workstations 205 are shown positioned on the separate tracks 225a, 225b, 225c, it is understood that multiple workstations 205 can be positioned on each of the tracks 225a, 225b, 225c. For example, each separate track 225a, 225b, 225c can be configured with three sequentially positioned workstations 205, as shown for the system 100 in FIG. 1.

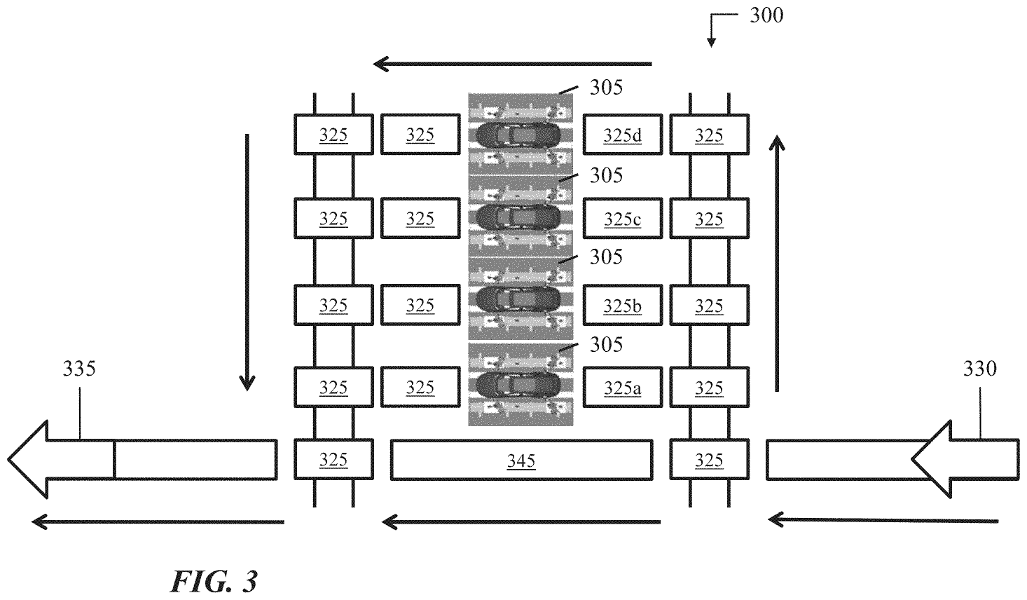

With reference to FIG. 3, a multi-track conveyor system 300 is shown having four workstations 305, where each workstation 305 is positioned within a separate track 325a, 325b, 325c, 325d that diverges from a common input track 330 and converges to a common output track 335. A bypass track 345 directly connects the input track 330 to the output track 335 and bypasses the separate tracks 325a, 325b, 325c, 325d and respective workstations 305. It should also be understood that there can be multiple tracks feeding into the input track 330 and multiple outputs departing from the output track 335. Likewise, the input track 330 can include multiple separate input tracks 330 and the output track 335 can include multiple separate output tracks 335. Multiple input tracks 330 and output tracks 335 can also include one or more additional bypass tracks 345. The embodiment of the multi-track conveyor system 300 is depicted as a power roll bed conveyor system that can use lift tables and skids to convey vehicles therethrough. Using the shown decision tree, vehicles can be routed through or around the automated workstations 305 depending on the skid type and repair types/length.

Although single workstations 305 are shown positioned on the separate tracks 325a, 325b, 325c, 325d, it is understood that multiple workstations 305 can be positioned on each of the tracks 325a, 325b, 325c, 325d. For example, each separate track 325a, 325b, 325c, 325d can be configured with three sequentially positioned workstations 305, as shown for the system 100 in FIG. 1.

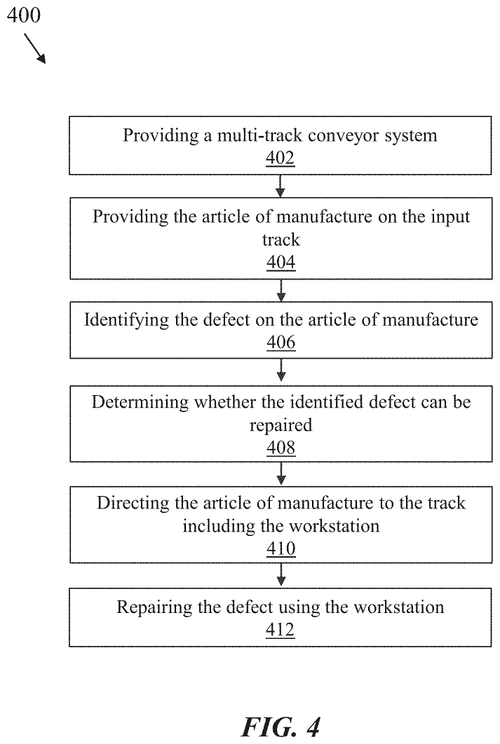

With reference to FIG. 4, a method 400 for repairing a defect on an article of manufacture is shown. The method 400 can include a step 402 of providing the multi-track conveyor system described herein. The method 400 can include a step 404 of providing the article of manufacture on the input track. A step 406 can include identifying the defect on the article of manufacture. The step 406 of identifying the defect on the article of manufacture is performed by the object inspection system. A step 408 of the method 400 can include determining whether the identified defect can be repaired. A step 410 can include directing the article of manufacture to the track including the workstation and the object of manufacture is directed to one of the tracks including the bypass track, the bypass track is configured to selectively receive the article of manufacture from the input track when a defect on the article of manufacture is either above a predetermined threshold or below a predetermined threshold, based on the defect identified. The method 400 can include a step 412 of repairing the defect using the workstation.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A multi-track conveyor system for repairing a defect on an article of manufacture, comprising:
an input track;
an output track; and
a plurality of tracks coupling the input track and the output track, wherein one of the tracks includes a workstation configured to repair the defect on the article of manufacture.

2. The multi-track conveyor system of claim 1, further comprising an object inspection system configured to identify the defect on the article of manufacture.

3. The multi-track conveyor system of claim 1, wherein the plurality of tracks includes another workstation.

4. The multi-track conveyor system of claim 3, wherein the workstation and the another workstation are on different tracks.

5. The multi-track conveyor system of claim 3, wherein the workstation and the another workstation are configured to repair different defects on the article of manufacture.

6. The multi-track conveyor system of claim 5, wherein the different defects are categorized by one of a location of the defect, a number of instances of the defect, a type of the defect, a predetermined time to repair the defect, and combinations thereof.

7. The multi-track conveyor system of claim 1, wherein one of the tracks of the plurality of tracks coupling the input track and the output track includes a plurality of workstations.

8. The multi-track conveyor system of claim 1, further comprising a bypass track coupled to the input track and another output track.

9. The multi-track conveyor system of claim 8, wherein the bypass track is configured to selectively receive the article of manufacture from the input track when the defect on the article of manufacture cannot be repaired by the workstation.

10. The multi-track conveyor system of claim 1, wherein the plurality of tracks includes a track without a workstation.

11. The multi-track conveyor system of claim 10, wherein the track without the workstation is configured to selectively receive the article of manufacture from the input track when the defect on the article of manufacture is below a predetermined threshold for repair of the defect on the article of manufacture.

12. The multi-track conveyor system of claim 1, further comprising a lift table configured to transport the article of manufacture to the workstation.

13. The multi-track conveyor system of claim 12, wherein the lift table is configured to transport the article of manufacture from the input track to the output track.

14. A method for repairing a defect on an article of manufacture, comprising steps of:
providing a multi-track conveyor system including:
an input track;
an output track; and
a plurality of tracks coupling the input track and the output track, wherein one of the tracks includes a workstation configured to repair the defect on the article of manufacture;
providing the article of manufacture on the input track;
identifying the defect on the article of manufacture;
directing the article of manufacture to the track including the workstation; and
repairing the defect using the workstation.

15. The method of claim 14, wherein the multi-track conveyor system further includes an object inspection system configured to identify the defect on the article of manufacture.

16. The method of claim 14, further comprising a bypass track coupled to the input track and another output track.

17. The method of claim 16, wherein the bypass track is configured to selectively receive the article of manufacture from the input track when the defect on the article of manufacture cannot be repaired by the workstation.

18. The method of claim 14, wherein the plurality of tracks includes a track without a workstation.

19. The method of claim 18, wherein the track without the workstation is configured to selectively receive the article of manufacture from the input track when the defect on the article of manufacture is below a predetermined threshold for repair of the defect on the article of manufacture.

20. The method of claim 14, wherein the plurality of tracks includes another workstation, the workstation and the another workstation are on different tracks, and the workstation and the another workstation are configured to repair different defects on the article of manufacture.
